(19) United States
(12) Patent Application Publication
(10) Pub. No.: US 2010/0264072 A1
(43) Pub. Date: Oct. 21, 2010

(54) Liquid-liquid extraction method apparatus

(75) Inventor: John R. Troost, Akron, OH (US)

Correspondence Address: John R. Troost, 2427 Chatham Road, Akron, OH, 44313, US

(73) Assignee: John R. Troost, Akron, OH (US)

(21) Appl. No.: 12/800,602

(22) Filed: May 19, 2010

Related U.S. Application Data
(63) Continuation-in-part of application No. 11/986,251, filed on Nov. 20, 2007.

(51) Int. Cl. B01D 17/02

(52) U.S. Cl. 210/95

(57) ABSTRACT

A bottle attachment designed to facilitate the separation of immiscible solvents following the liquid-liquid extraction of organic compounds from water in original sampling bottles.

### CROSS-REFERENCE TO RELATED APPLICATIONS

Continuation-in 0part of Ser. No. 11/986,251, filed Nov. 20, 2007, pending.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates in general to an apparatus born of a new method for extracting organic chemicals from water. More specifically, the invention relates to an apparatus to separate solvents following the liquid-liquid extraction of organic compounds from water in original sampling bottles.

Water is routinely sampled and tested for health and a number of other concerns. Most chemical analysis methods involve the removal of organic chemicals from water by partitioning into an immiscible solvent, often heavier than water, by a process known as liquid-liquid extraction. The chemicals to be extracted must have a greater affinity for the solvent than the water and the solvent must be sufficiently interacted with the water for the process to be efficient. There are two common techniques.

The most common features a separatory funnel, a pear shaped vessel fashioned with a cap on one end and narrow opening with a stop-cock on the other in which a water sample and an extracting solvent are added together and vigorously shaken for a period of time. Afterwards, the separatory funnel is stood upright and the liquid layers are allowed to settle until a clear demarcation between the liquid layers may be observed. Removing the cap and manipulating the stop-cock, the lower layer is manually drained off into another container by observing the movement of the interface between the two fluids.

The liquid housing of the separatory funnel must necessarily be clear or at least translucent to facilitate viewing a moving interface. The procedure is often repeated with fresh solvent to maximize the yield of the chemicals to be extracted from the water. The separatory funnels may be shaken manually or mechanically with elaborate machinery.

A separatory funnel, therefore has a dual purpose—to provide a mixing chamber for water and an extracting solvent and to serve as a vehicle for separating the two liquids following the extraction.

An example of a separatory funnel may be found in U.S. Pat. No. 3,656,912 issued to Ken Sugawara on Apr. 18, 1972. This patent actually incorporates an innovation to the funnel whereby one of the separated liquid layers is stored in a secondary chamber so that it may be subsequently reintroduced into the main chamber for an additional extraction, eliminating exposure to additional containers and a potential for contamination of the extract.

U.S. Pat. No. 5,478,478 issued to Sandra Griswold on Dec. 26, 1995 introduced a modification to facilitate the separation of two fluids within a separatory funnel by preventing vortexing. U.S. Pat. No. 5,496,110 issued to James Geier and Jeff Newman on Mar. 5, 1996 automates the separatory funnel shaking procedure to allow a number of extractions to take place simultaneously.

The second common technique, continuous liquid-liquid extraction, makes use of an elaborate glass apparatus to automate the extracting process. A heavier than water solvent (typically methylene chloride) is boiled in a flask and vaporized up into a cold water jacket. The condensed solvent drips into a second flask containing the water sample. The boiling flask is connected to the water flask by a tube allowing an overflow of solvent to return to the boiling flask to be repeatedly vaporized and dripped through the water. Chemicals are stripped from the water accumulating in the solvent inside the boiling flask.

The initial process generally takes 18 to 24 hours and is most often repeated by a second extraction of 18 to 24 hours after altering the pH of the water sample. U.S Pat. No. 4,567,020 is an early example of this process.

With a fairly new technique, organic compounds may also be removed from water by passing the water through a solid sorbent material from which the pollutants may subsequently be dislodged with solvent or a mixture of solvents.

With these procedures, the extracting solvent, now containing the chemicals originally in the water, is separated from the water and usually reduced in volume (concentrated) by evaporation to enable the extracted organic compounds to be detected at extremely low levels. All of these processes are labor intensive, costly, time-consuming and subject to contamination.

This invention introduces an alternative procedure and device needed to fulfill it. After removing a small amount of the water, solvent(s) or solvent and salt is added directly to a water sample in original bottles (those actually used to collect, transport and store water samples collected in the field) to effect the extraction of organics constituents with at least equal but generally enhanced efficiency as the traditionally employed processes described above.

By gently (12 RPM) turning the bottles, typically 1 liter in size, horizontally on rails (on an rotisserie designed for this purpose) for a 12 hour period, the extracting process of a separatory funnel is reproduced and the specifications for a number of standard environmental methods are readily achieved. A comprehensive array of important environmental pollutants is efficiently extracted from water with a minimum of labor and expense. By attaching a customized cap and adapter directly to the bottle following the mixing process and inverting the bottle on a stand, the bottle becomes equipped to replicate the liquid phase separation function of the separatory funnel. Thus, both functions of the traditional separatory funnel are able to be performed utilizing only the original sample container with distinct advantages. The use of ozone depleting solvents, expensive laboratory glassware and labor is sharply curtailed, automation is achieved, precision is enhanced and contamination is minimized over the prior art.

Bottle cap attachments observed in the prior art are of significantly different form and function. U.S. Pat. No. 3,994,423 issued to Donald Burg Nov. 30, 1976 attaches tubes to a bottle for the purpose of dispensing drops of liquid. The invention functions only with the bottle upright and has no design features to detect and effect the separation of immiscible liquids. U.S. Pat. No. 4,525,276 issued to Shozo Toda and Kenji Yasuda Jun. 25, 1985 separates immiscible liquids by connecting two bottles together with a cap containing a “downcomer” and “pipe” as well as a porous membrane. While the function of this device is the same as the current invention, the process and the form are quite different. U.S. Pat. No. 4,754,891 issued to Jack Srebnik and Robert Reese Jul. 5. 1988 contains tubes penetrating a bottle cap but has no mechanism to detect and effect the separation of immiscible liquids. It also cannot function while inverted.

### BRIEF SUMMARY OF THE INVENTION

The invention is a bottle attachment born of an innovative new method (bottle liquid-liquid extraction—BLLE) replacing the function of a separatory funnel as a mechanism for extracting organic chemicals from water.

More specifically, the invention entails a bottle cap for attachment to a bottle comprising: a cap having an open hole; two clear or translucent tubes one large, one small, fashioned with a rim on one end, the tubes extending outwardly from the cap; said rim forming a seal with the cap; the larger of said clear or translucent tubes graduating down in diameter from the rim to a smaller opening or attaching to a stop-cock at the end opposite the rim; the smaller tube penetrating the rim, shorter in length serving to form or, alternatively, to house and seal a vent tube extending internally to the full length of the bottle, and the other end extending outside the cap. The attachment may be fabricated with the cap as one piece.

It should be appreciated by those skilled in the art that the conception and the specific embodiments disclosed may be readily utilized as a basis for modifying or designing other structures for carrying out the same purpose of the present invention. It should also be realized by those

skilled in the art that such equivalent constructions do not depart from the spirit and scope of the invention as set forth in the claim of the invention.

### BRIEF DESCRIPTION OF THE DRAWINGS

For a more complete understanding of this invention and the advantages thereof, reference is made to the following descriptions taken in conjunction with the accompanying drawings in which:

FIG. 1 is a diagrammatic view of one embodiment of a bottle equipped with a cap attachment; the bottle inverted to enable the visual separation of a heavier than water solvent from water; and

FIG. 2 is a diagrammatic view of one embodiment of a bottle cap adaptor featuring a stop-cock and removable vent tube; and

FIG. 3 is a diagrammatic view of another embodiment of a bottle cap adaptor featuring a beveled funnel with a thin walled section fashioned at the narrow end opposite the rim providing a manual crimping area to control the flow and separation of liquid layers using fingers, eliminating a need for a stop-cock; and

FIG. 4 is a diagrammatic view of an open holed cap that would serve to house and seal the adaptors of FIG. 2 and FIG. 3 to a bottle.

### DETAILED DESCRIPTION OF THE INVENTION

Embodiments of the inventive bottle cap attachment are given in

the accompanying drawings.

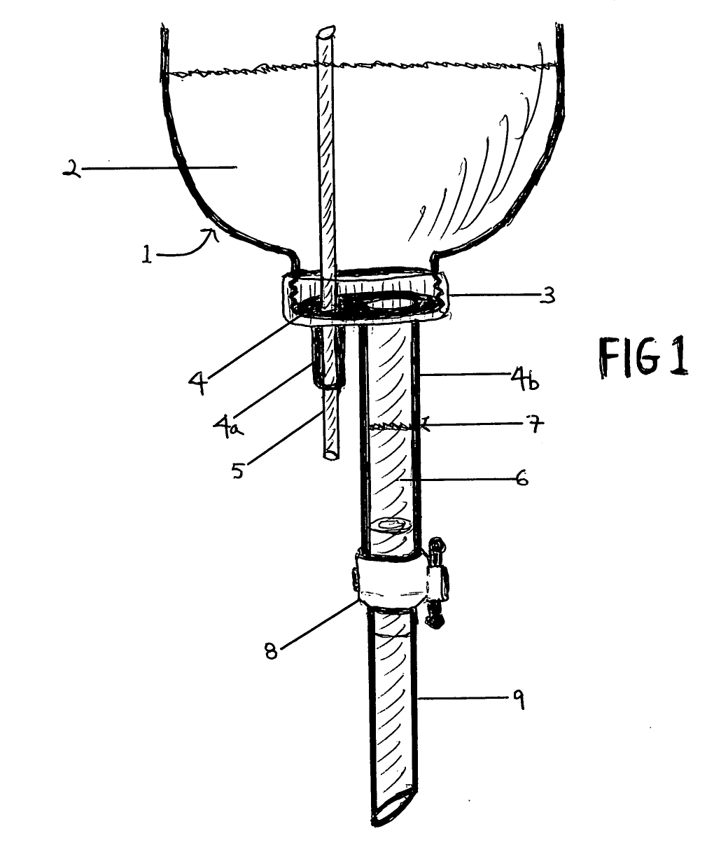

As shown in FIG. 1, an inverted bottle 1 (typically glass, narrow mouth, screw-cap, 1-liter in size) containing water 2 and a liquid heavier than water 6 (extracting solvent), is equipped with a cap 3 and a cap insert containing a rim 4, tube 4a and a larger tube 4b with the rim fashioned to it to form a seal with the cap 3. The rim 4 and tubes 4a and 4b fabricated of one piece of clear or translucent, inert, compressible, pliable fluorocarbon polymer material such as fluorinated ethylene propylene to enable the viewing of the interface 7 between the liquid layers, provide a leak-free seal between the cap 3 and the lid of the bottle 1, and be resistant to damage from chemically aggressive solvents often used to extract organic chemicals from water. The larger tube 4b attaching to a stop-cock 8 which in turn attaches to a downcomer 9. The smaller tube 4a forming a sealing encasement into which a separate vent tube 5 may be inserted to extend from outside the bottle up inside the bottle 1 to the full length of the bottle 1.

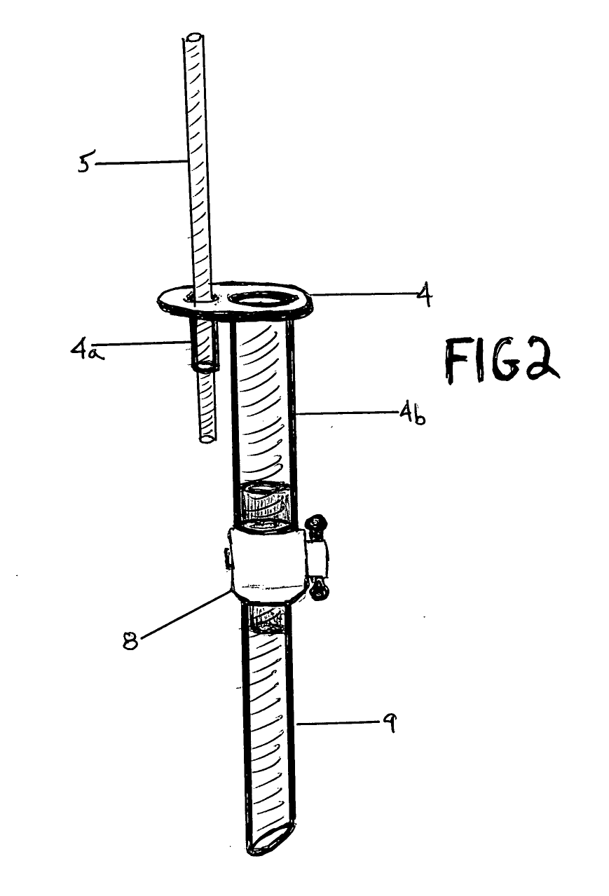

FIG. 2 provides a diagrammatic view of the bottle cap attachment detached from the bottle and cap with greater detail of the rim 4 fused to tubes 4a and 4b.

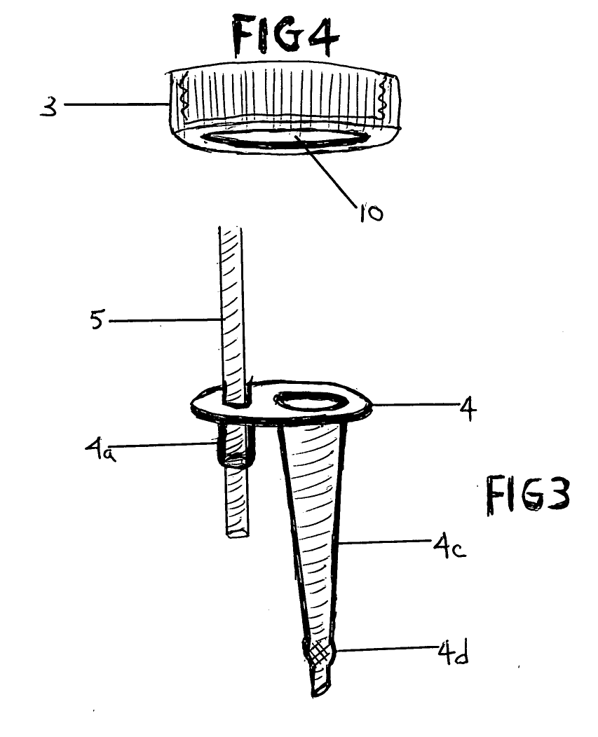

FIG. 3 exhibits another embodiment of the bottle cap attachment eliminating the need for a stop-cock. The features of this alternative embodiment are the same as those of FIG. 2 with the exception of larger tube 4b. The larger tube 4c is funnel shaped graduating from a larger diameter at the rim to a smaller diameter at the end opposite the rim with a thin walled zone 4d near the narrow end to provide and demarcate a crimping area that a technician's fingers may grasp to manage the flow to control the separation of the liquid layers without a stop-cock.

FIG. 4 is a diagrammatic view of a screw-on bottle cap 3 fashioned with an open hole 10 through which the adaptor may be inserted. The opening in the bottle cap 10 is of smaller diameter than the outer diameter of the rim 4 of FIGS. 1, 2 and 3 to provide a sealing surface between the cap 3 and the rim 4. The rim 4 also serves as the liner for cap 3 providing a compressible, inert surface for which to form a leak-free seal between the adaptor and the lip of the bottle 1.

What is claimed is:

1. A bottle attachment to enable an inverted bottle to conduct the separation of immiscible liquids comprising:
a bottle cap having an open hole;
two rigid tubes, one smaller, one larger fashioned with a rim on one end, the tubes extend outwardly from the bottle cap;
said rim forming a seal to the bottle lid;
a stop-cock attached to the larger tube at the end opposite the rim;
the smaller tube forming a vent tube extending internally to the full length of the bottle, and the other end extending outside the cap;
said attachment being made of fluorinated ethylene propylene, polytetrafluoroethylene or any other clear or translucent material to facilitate the viewing of an interface between immiscible liquids within the larger tube.

2. The bottle attachment as claimed in claim 1 wherein the smaller tube forms an encasement to house and seal a separate vent tube.

3. The bottle attachments as claimed in claims 1 and 2 wherein the clear or translucent larger tube is funnel shaped graduating from a larger diameter at the rim to a smaller diameter at the end opposite the rim;
the smaller diameter of said tube of sufficient thin-walled pliability to enable the flow of immiscible liquid layers to be controlled by the grasp of human fingers.

4. The bottle attachments of claims 1, 2 and 3 wherein the bottle cap and tube attachments are fabricated together in one piece.
